(19) United States
(12) Patent Application Publication
(10) Pub. No.: US 2026/0180973 A1
(43) Pub. Date: Jun. 25, 2026

(54) AUTHENTICATION USING PERSISTENT TOKEN AND MDM CERTIFICATE

(71) Applicant: Palo Alto Networks, Inc., Santa Clara, CA (US)

(72) Inventors: Hannah Ye, Mountain House, CA (US); Kaushal Deo, Newark, CA (US); Adam Amir Syed, San Francisco, CA (US)

(21) Appl. No.: 18/987,548

(22) Filed: Dec. 19, 2024

(51) Int. Cl. H04L 9/40

(52) U.S. Cl. CPC H04L 63/0823; H04L 63/0272; H04L 63/083

(57) ABSTRACT

The present application discloses a method, system, and computer system for caching a persistent token on a client device and using a mobile device management (MDM) and the persistent token for authenticating the client device to access certain network resources. The method includes: (i) determining whether a persistent token is cached locally on a client, (ii) in response to determining that the cached persistent token is not cached locally on the client, sending from the client a request for the persistent token to a token resource, and obtaining a new persistent token, and (iii) authenticating the client with a portal using the persistent token. A cached persistent token is used for authentication in response to a determination that the cached persistent token is cached locally on the client. The new persistent token is used for authentication in response to determining that the persistent token is not cached locally on the client.

### BACKGROUND OF THE INVENTION

In modern enterprise and secure network environments, resources are often protected behind multiple layers of portals or gateways to ensure that only authorized users and devices can access them. These resources may include sensitive data, internal systems, or secure internet services. Current systems typically rely on a combination of authentication mechanisms at each gateway layer, creating a multi-step process that verifies the identity of the client device and user at each stage. This layered approach enhances security by requiring different credentials or tokens at various access points, reducing the risk of unauthorized access even if one layer is compromised.

### BRIEF DESCRIPTION OF THE DRAWINGS

Various embodiments of the invention are disclosed in the following detailed description and the accompanying drawings.

FIG. 1 is a block diagram of an environment for accessing an enterprise gateway according to various embodiments.

FIG. 2 is an example of a client device user interface for prompting a user to permit use of a persistent token according to various embodiments.

FIGS. 3A and 3B are collectively a sequence diagram for accessing resources behind a first portal and a second portal according to various embodiments

FIG. 4 is a sequence diagram for using a persistent token certificate that is not cached locally at a client device when authenticating to access resources behind a second gateway according to various embodiments.

FIG. 5 is a sequence diagram for using a cached persistent token certificate when authenticating to access resources behind a second gateway according to various embodiments.

FIG. 6 is a sequence diagram for using a persistent token certificate for a persistent token in connection with authenticating a client when accessing resources behind a second gateway according to various embodiments.

FIG. 7 is a sequence diagram for using a persistent token certificate for a persistent token in connection with authenticating a client when accessing resources behind a second gateway according to various embodiments.

FIG. 8 is a flow diagram of a method for using a persistent token for authenticating a client with a portal according to various embodiments.

FIG. 9 is a flow diagram of a method for using a persistent token for authenticating a client with a second portal in connection with accessing resources behind a second portal that is behind a first portal according to various embodiments.

FIG. 10 is a flow diagram of a method for using a persistent token for authenticating a client to access resources behind a plurality of gateways according to various embodiments.

FIG. 11 is a flow diagram of a method for using a persistent token certificate that is not cached when authenticating a client to access resources behind a plurality of gateways according to various embodiments.

FIG. 12 is a flow diagram of a method for caching a persistent token certificate for subsequent authentications of a client when accessing resources behind a plurality of gateways according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a security entity may be a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

Various embodiments provide a method, system, and computer system for caching a persistent token on a client device and using a mobile device management (MDM) and the persistent token for authenticating the client device to access certain network resources. The method includes: (i) determining whether a persistent token is cached locally on a client, (ii) in response to determining that the cached persistent token is not cached locally on the client, sending from the client a request for the persistent token to a token resource, and obtaining a new persistent token, and (iii) authenticating the client with a portal using the persistent token. A cached persistent token is used for authentication in response to a determination that the cached persistent token is cached locally on the client. The new persistent token is used for authentication in response to determining that the persistent token is not cached locally on the client.

In enterprise environments and secure network systems, client devices often require access to resources located behind multiple layers of portals or gateways. These resources may include sensitive internet-based or enterprise-specific resources. Ensuring that only authorized devices and users can access these resources necessitates robust authentication mechanisms. However, traditional multi-layer authentication processes, while secure, often degrade the user experience due to frequent prompts for authentication credentials. This is especially true when authentication relies on tokens or certificates that require repeated user interaction.

The first layer of access is often managed by a centralized security service, which authenticates devices using tokens or certificates provisioned through Mobile Device Management (MDM) systems. MDM systems are widely deployed in enterprises to enforce security policies and provision authentication credentials. At this stage, devices typically authenticate using an MDM certificate or token that is tightly managed by the organization's IT infrastructure. Once authenticated, the client device may attempt to access resources behind a second gateway, often controlled by an enterprise-specific system. Authentication at this second layer frequently requires additional credentials, such as persistent tokens, which are issued and managed separately from the initial layer. However, when client devices need to authenticate with the second layer, such as a secondary, enterprise-specific gateway using persistent tokens, the process can become cumbersome due to operating system constraints that frequently require user intervention.

While this architecture provides robust security, it introduces significant complexity for users and devices. Persistent tokens required for the second gateway are often stored securely on the client device, but their use typically requires user authorization or additional authentication steps. Furthermore, if a device lacks a locally stored token or if the token has expired, the client must authenticate with a provisioning gateway to obtain a new token. This multi-layered process ensures security but can degrade the user experience, as repeated prompts for credentials or token provisioning may disrupt workflows. These challenges highlight the need for improved mechanisms to streamline authentication while preserving the integrity of secure systems.

In the context of iOS, the Mobile Device Management (MDM) system exclusively supports authentication using a single certificate. This limitation poses challenges when there is a need for different client certificates to authenticate to diverse gateways, or when clients opt not to use the MDM client certificate for authentication. This scenario is particularly relevant when there is a requirement for on-demand or per-application VPN connectivity, which mandates the use of client certificate authentication to ensure seamless connectivity. Furthermore, certain use cases demand additional authentication using client certificates or the use of different certificates in order to gain access to specific gateways. Additionally, users may encounter situations wherein connecting to a primary gateway is essential to procure the necessary credentials for accessing more restricted gateways within the network. Amidst these complexities, the current MDM support framework in iOS presents challenges when multiple client certificates are required for authentication across different gateways or when alternative authentication methods are necessary. Consequently, the need to seamlessly navigate between gateways, while accommodating diverse authentication requirements and access restrictions, highlights the complexities involved in ensuring secure and efficient connectivity within the MDM environment on iOS.

Various embodiments address these challenges by integrating MDM authentication with persistent token management and introducing a certificate caching mechanism that improves usability while maintaining security. The system enables seamless and secure authentication for client devices accessing resources through a multi-gateway structure.

According to various embodiments, the client device first uses an MDM token, such as an MDM certificate (e.g., the MDM certificate associated with the MDM token), to authenticate with the first gateway provided by a security service. To authenticate with the second gateway, which is enterprise-specific, the client device utilizes a persistent token (e.g., a certificate associated with the persistent token, such certificate may be referred to herein as a persistent token certificate). If the persistent token is not stored locally on the device, the client device authenticates with a provisioning gateway using the MDM certificate. Upon successful authentication, the provisioning gateway issues the persistent token to the client device, enabling it to proceed with authentication at the second gateway.

In some embodiments, the secondary gateway is the default gateway to which the client device is to connect. If a user has the required persistent token to authenticate to the secondary gateway, the client device will authenticate with the second gateway using the persistent token without connecting to the first gateway. In some embodiments, if the client device does not have the persistent token (e.g., pre-stored), the user uses the client device to manually connect to the first gateway using the MDM certificate, download a persistent token for the user, and then switch to the secondary gateway.

According to various embodiments, the system caches certificates associated with the persistent token(s) within the client device's keychain. Before attempting to authenticate with the second gateway, the client device queries the keychain for a cached certificate. If the cached certificate is available, the client device uses it to authenticate with the second gateway, eliminating the need for repeated user prompts; provided that in some embodiments, even if the system has a cached certificate, the system may provide a prompt to the user for authorization to use the cached certificate when authenticating using the cached certificate. If no cached certificate is found, the client device searches for the persistent token, prompts the user for authorization, and uses the token for authentication. Once authenticated, the certificate is cached in the keychain for future use, streamlining subsequent authentication processes.

The persistent token certificate caching techniques significantly enhances the user experience by reducing the frequency of user prompts during authentication, while maintaining high security standards. The integration of MDM and persistent token management ensures secure provisioning and use of tokens, while the certificate caching mechanism optimizes device performance and network efficiency. Enterprises deploying secure access solutions can benefit greatly from this invention, as it offers a practical approach to managing secure authentication processes in environments where both usability and security are critical.

According to various embodiments, the system implements an application (e.g., running at a client device) that is configured to act as a client certificate provider for authentication, particularly when used in conjunction with an MDM solution. The use of this application as a client certificate provider empowers administrators to utilize the specialized application to push certificates to authenticated users, enabling the extension of these certificates to VPN applications. This extension provides the capability to connect to different gateways with distinct client certificates, thereby enhancing secure connectivity across the network environment. Within the application, a persistent token mechanism is implemented to procure the required certificates for controlling gateway authentication. This mechanism ensures that the necessary certificates are readily available, thereby streamlining and optimizing the authentication process within the network environment. This mechanism may also grant administrators the necessary control to manage certificates using the application, further enhancing security and management capabilities. For example, network administrators may desire to use persistent tokens is that they can enforce their own authentication requirements to obtain the persistent token. For example, the administrator may require that a physical authentication card be used in order to obtain the persistent token. By leveraging this application in conjunction with the MDM solution, administrators can efficiently extend certificates to VPN applications and maintain a high level of control over certificate management, ensuring secure and seamless connectivity across diverse gateways within the network.

According to various embodiments, the system has a certificate tied to (e.g., associated with) a VPN profile (e.g., configurations and authentication methods, etc.). The system can use both a token stored in association with the MDM application (e.g., the MDM certificate) and/or a persistent token provided by a third party (e.g., a party different from the security service providing the MDM application). In some embodiments, the VPN profile comprises a single certificate, however, the application can access a cached certificate for a persistent token via the client device keychain. Related art systems previously required a user to choose between an application that would use a VPN profile with a certificate or use an external token resource. The system now enables permissions to use the MDM token (or corresponding MDM certificate) and the persistent token(s) (or corresponding persistent token certificate(s)) at the same time.

Some of the advantages of the system or process implementing techniques according to various embodiments described herein include:
Enhanced Authentication Flexibility: The application configured to act as a client certificate provider enables the authentication of users using distinct client certificates, offering flexibility in meeting diverse authentication requirements across different gateways.
Seamless VPN Connectivity: By extending certificates to VPN applications, the system facilitates the ability to connect to various gateways with different client certificates, ensuring secure and seamless connectivity as per the specific needs of the users and the network environment.
Efficient Certificate Management: The persistent token mechanism within the application streamlines and optimizes the acquisition and management of required certificates for gateway authentication, providing a seamless and user-friendly experience for administrators.
Enhanced Security Control: Administrators are empowered with enhanced control over certificate management through the specialized application, ensuring that certificates can be managed in a secure and efficient manner, thereby maintaining a high level of security within the network environment.
Step-up authentication: The system enables customers to authenticate users with the primary gateway, granting access to specialized applications for obtaining the essential certificates required to extend access to restricted gateways with minimal user intervention.

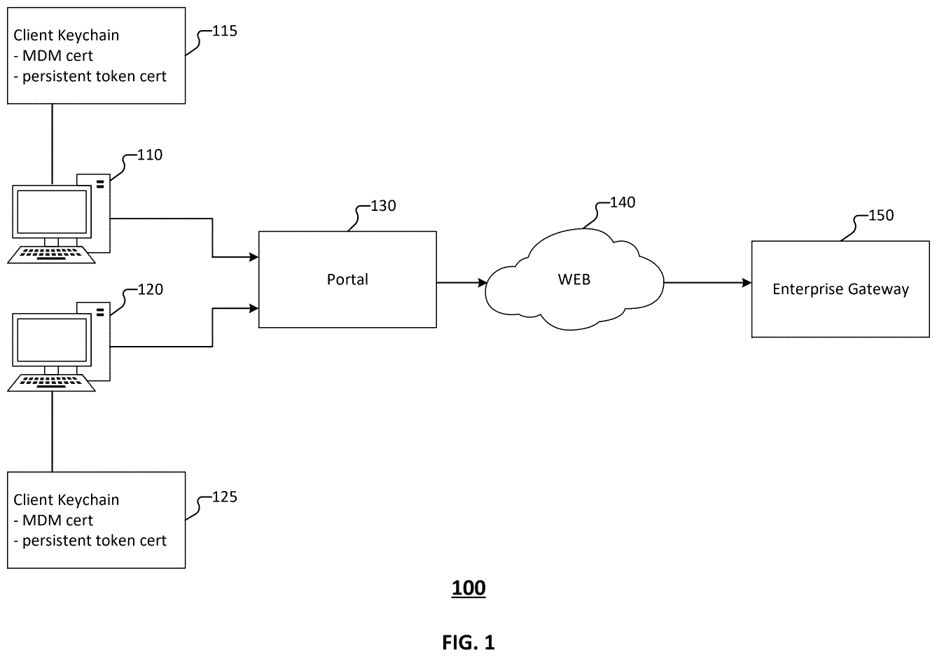

FIG. 1 is a block diagram of an environment for accessing an enterprise gateway according to various embodiments. In the example shown, system 100 comprises an enterprise gateway 150 that resides behind another portal or gateway, such as behind portal 130. Enterprise gateway 150 can be a second layer (or an additional layer) of security behind the portal or gateway, such as behind portal 130. Authentication with enterprise gateway 150 can expose certain resources (e.g., internet resources or applications). In some embodiments, portal 130 can be a portal or gateway that is provided by a security service and enterprise gateway 150 can provide a gateway to a customer-specific network (e.g., a customer of the security service). A client device (e.g., client 110 or client 120) can access resources behind enterprise gateway 150 by first accessing portal 130 via authentication with portal 130 and then authenticating and accessing enterprise gateway 150 via the web 140 or network connectivity.

According to various embodiments, a client device authenticates with portal 130 using an MDM token or corresponding MDM certificate. In some embodiments, the client device can authenticate with portal 130 using either the MDM certificate or a persistent token certificate, which is also used to authenticate with enterprise gateway 150.

According to various embodiments, a client device (e.g., client 110, client 120, etc.) may store an MDM token and one or more persistent tokens.

The MDM token may be provisioned on the client device in connection with the installation or running of an MDM application on the client device. In some embodiments, the MDM certificate can be cached such as in the MDM application, the VPN profile, or the client device's keychain or other caching mechanism (e.g., client keychain 115 for client 110, client keychain 125 for client 120, etc.). In other embodiments, the MDM certificate is not cached and is obtained from the MDM application when needed for authentication. For example, the MDM certificate may not need to be cached if it is stored in (or in connection with) the MDM application because the MDM application is configured with wildcard access and does not require user permission each time the MDM certificate is to be used. For example, if the MDM certificate is put in the MDM application, the MDM application can be configured to identify one or more applications that are permitted to access the MDM certificate and upon such a configuration, the one or more applications can invoke the MDM certificate anytime they want without further user permission or interaction.

The one or more persistent tokens may be provisioned for the client device by one or more provisioning gateways, such as a provisioning gateway(s) that resides behind portal 130 via which the client device uses the MDM token (or corresponding MDM certificate) to authenticate. The provisioning gateways may have additional authentication requirements to confirm the identity of the user, such as based on a security badge, authentication cards, etc. In response to authenticating with the provisioning gateway, the provisioning gateway can push a persistent token to the client device, such as to an application running on the client device (e.g., a persistent token application or other specialized application that is separate from the MDM application, etc.). Additionally, or alternatively, the provisioning gateway may push the application to the client device for storage or management of the persistent token provided by the provisioning gateway. In some embodiments, the provisioning gateway does not push the persistent token to the client device. Rather, the provisioning gateway allows the client device access to a provider application that pushes the persistent token. In some embodiments, the persistent token is stored in the persistent token.

In some embodiments, the client device (e.g., client 110, client 120, etc.) stores the persistent token locally, after receiving the persistent token via authenticating with the corresponding provisioning gateway. The client device can store the persistent token in (or in association with) a particular application, such as an application associated with (or managed by) a third party that is different from the security service that provides/manages the MDM application on the client device.

According to various embodiments, after a persistent token (e.g., a corresponding persistent token certificate) is used for a successful authentication, the client device can cache the persistent token certificate for use in subsequent authentications in a manner that does not require an additional user intervention to provide express authorization for the use of the persistent token. As an example, the system stores (e.g., caches) the persistent token certificate in the client keychain (e.g., the keychain on iOS), which can be accessed for future authentications. The client keychain can be an encrypted database local to the client device. In some embodiments, even if the cached persistent token (e.g., persistent certificate) is used for authentication, the client device will provide a single prompt to the user to allow the application to access the private key of the persistent token. In the example shown, client 110 comprises client keychain 115 in which a persistent token certificate is stored. The corresponding MDM certificate may also be stored in the client keychain 115. Similarly, client 120 comprises client keychain 125 in which a persistent token certificate is stored. The client keychain may be protected by the client device's passcode so that only the owner/appropriate user of the client device can access the data that is stored in it. In some embodiments, when the user wants to authenticate with a gateway, the user can unlock the client device and the cached persistent token certificate, if any, can be retrieved from the client keychain and used for authenticating the client device with the gateway.

In some embodiments, each protected keychain item—like a certificate, password or private key—has an associated access instance that contains an access control list (ACL). The entries in this list in turn each contain an array of operations and an array of applications trusted to carry out those operations with the item. The collection of ACL entries govern the accessibility of the corresponding keychain item. Accordingly, various embodiments cache persistent token certificate for use by one or more trusted applications (e.g., applications specified/enumerated by the user or administrator of the client device, or application for which an authentication was successfully performed using the persistent token certificate).

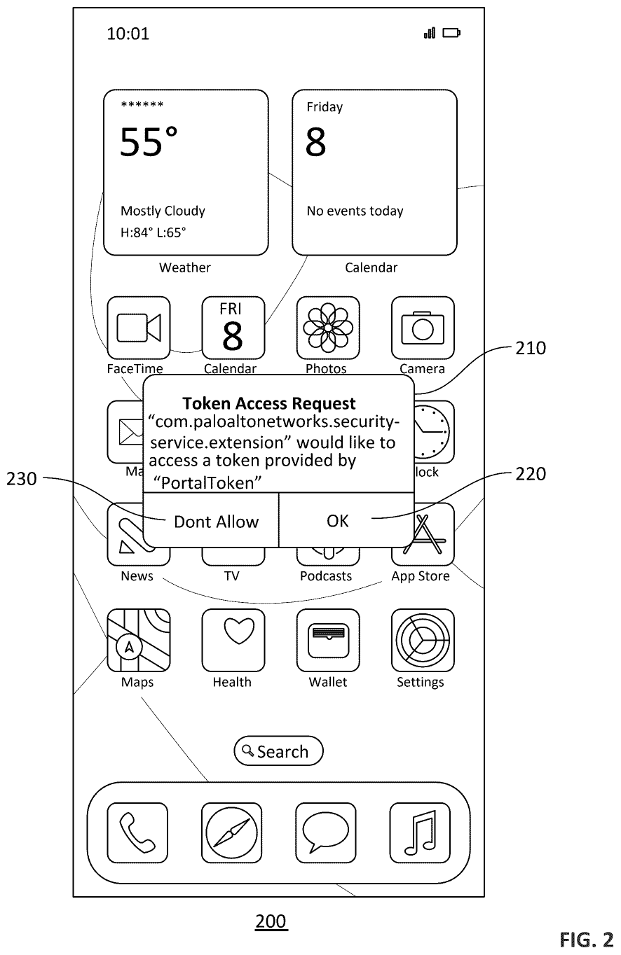

According to various embodiments, when an application attempts to access a keychain item for a particular purpose—for example, using a persistent token certificate to authenticate with a gateway (e.g., enterprise gateway 150)—the system looks for an entry in the item's ACL containing the operation. If the item's ACL does not comprise an entry that lists the operation, then the system denies access, in which case the third party application can attempt to use a different certificate or token for authentication or notify the user such as to prompt the user for permission to use the persistent token or persistent token certificate. Conversely, if the items ACL comprises an entry that lists the operation (e.g., for use in authenticating with the gateway), the system checks whether the calling application is among the entry's trusted applications. If so, the system grants access to the keychain item (e.g., the persistent token certificate). Otherwise, the system prompts the user for confirmation or permission, such as by configuring and presenting to the user (e.g., displaying) user interface 200 of FIG. 2. The user may choose to Deny, Allow, or Always Allow the access to the keychain item. In the latter case, the system adds the application to the list of trusted applications for that entry, enabling the application to gain access in the future without prompting the user again.

According to various embodiments, portal 130 can be a security entity, such as a firewall. For example, portal 130 can be a next generation firewall or a remote security platform that are provided by a security service.

### Advanced or Next Generation Firewalls

Malware is a general term commonly used to refer to malicious software (e.g., including a variety of hostile, intrusive, and/or otherwise unwanted software). Malware can be in the form of code, scripts, active content, and/or other software. Example uses of malware include disrupting computer and/or network operations, stealing proprietary information (e.g., confidential information, such as identity, financial, and/or intellectual property related information), and/or gaining access to private/proprietary computer systems and/or computer networks. Unfortunately, as techniques are developed to help detect and mitigate malware, nefarious authors find ways to circumvent such efforts. Accordingly, there is an ongoing need for improvements to techniques for identifying and mitigating malware.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices, and in some implementations, certain operations can be implemented in special purpose hardware, such as an ASIC or FPGA).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as described herein). A firewall can also filter local network (e.g., intranet) traffic by similarly applying a set of rules or policies.

Security devices (e.g., security appliances, security gateways, security services, and/or other security devices) can perform various security operations (e.g., firewall, anti-malware, intrusion prevention/detection, proxy, and/or other security functions), networking functions (e.g., routing, Quality of Service (QoS), workload balancing of network related resources, and/or other networking functions), and/or other security and/or networking related operations. For example, routing can be performed based on source information (e.g., IP address and port), destination information (e.g., IP address and port), and protocol information (e.g., layer-3 IP-based routing).

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series firewalls).

For example, Palo Alto Networks' next generation firewalls enable enterprises to identify and control applications, users, and content—not just ports, IP addresses, and packets—using various identification technologies, such as the following: App-ID for accurate application identification, User-ID for user identification (e.g., by user or user group), and Content-ID for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency).

Advanced or next generation firewalls can also be implemented using virtualized firewalls. Examples of such next generation firewalls are commercially available from Palo Alto Networks, Inc. (e.g., Palo Alto Networks' firewalls, which support various commercial virtualized environments, including, for example, VMware® ESXi™ and NSX™, Citrix® Netscaler SDX™, KVM/OpenStack (Centos/RHEL, Ubuntu®), and Amazon Web Services (AWS)). For example, virtualized firewalls can support similar or the exact same next-generation firewall and advanced threat prevention features available in physical form factor appliances, allowing enterprises to safely enable applications flowing into, and across their private, public, and hybrid cloud computing environments. Automation features such as VM monitoring, dynamic address groups, and a REST-based API allow enterprises to proactively monitor VM changes dynamically feeding that context into security policies, thereby eliminating the policy lag that may occur when VMs change.

FIG. 2 is an example of a client device user interface for prompting a user to permit use of a persistent token according to various embodiments. In the example shown, user interface 200 can be configured with a pop-up or prompt 210 that requests the user to select whether the client device (e.g., an application on the device) is permitted to access a persistent token stored on the client device. In some embodiments, the operating system (e.g., iOS) running on the client device requires express permission from the user to permit applications running on the client device to use the persistent token, such as when authenticating with a gateway (e.g., a second gateway that resides behind a first gateway for which an MDM certificate can be used for authentication). In some embodiments, if the persistent token certificate (e.g., the certificate for the persistent token) is cached locally on the client device, the system can avoid having to configure user interface 200 with prompt 210. For example, the system can cache the context for the use of the persistent token certificate by a particular application in connection with authenticating with a particular gateway or portal. As illustrated, prompt 210 comprises button 220 that is a selectable element and can be used for the user to input the selection to permit the application to access the persistent token stored on the client device. Prompt 210 additionally comprises button 230 that is a selectable element and can be used for the user to input the selection to deny the application's access of the persistent token.

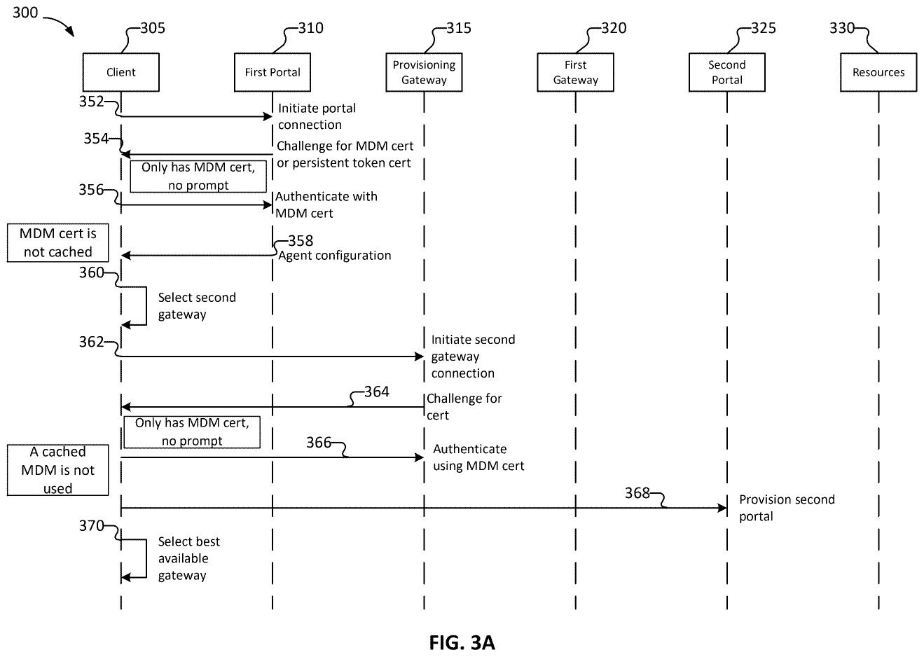

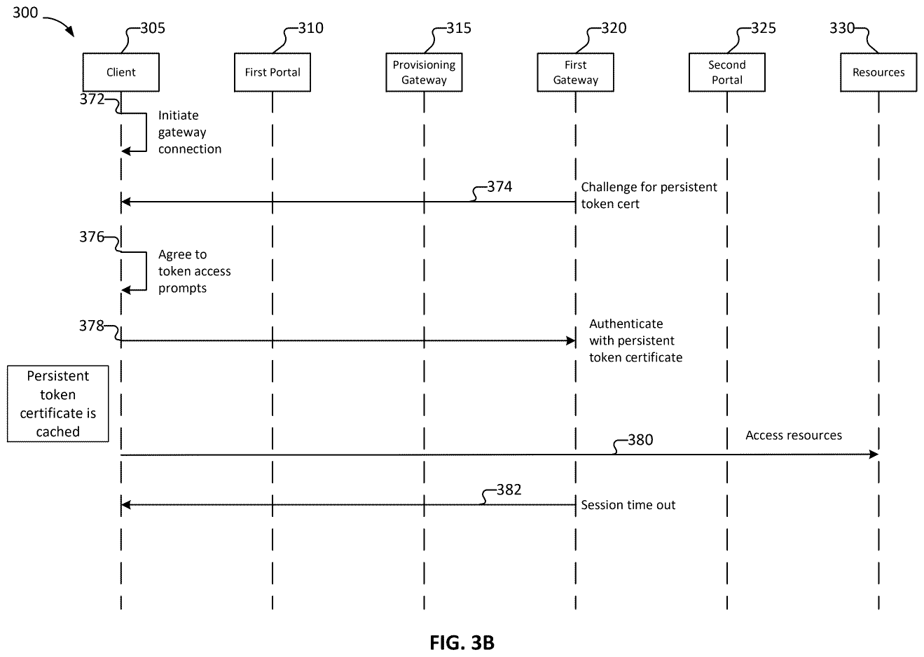

FIGS. 3A and 3B are collectively a sequence diagram for accessing resources behind a first portal and a second portal according to various embodiments. In the example shown, system 300 comprises client 305 (e.g., a client device), a first portal 310 (e.g., a portal for which an MDM certificate can authenticate client 305), a provisioning gateway 315, a first gateway 320, and a second portal 325 (e.g., a token resource). System 300 may additionally comprise resources 330 (e.g., internet resources, application resources, files, etc.), which reside behind second portal 325. In some embodiments, second portal 325 is a token resource that is accessed and installed onto client 305 after authenticating with provisioning gateway 315.

At 352, client 305 initiates a portal connection with the first portal 310. In response to receiving the request to initiate the portal connection, at 354, the first portal 310 challenges client 305 for an MDM certificate or a persistent token certificate. For example, the first portal 310 sends to client 305 a request for a certificate to authenticate client 305 with the first portal 310. As shown, client 305 only has an MDM certificate (e.g., client 305 does not comprise a persistent token or corresponding persistent token certificate). Because the client 305 uses the MDM certificate to authenticate with the first portal 310, the client 305 does not need to prompt the user for permission to use the MDM certificate. At 356, the client 305 provides the MDM certificate to first portal 310 and first portal 310 authenticates the client 305 based on the MDM certificate. In response to determining that the client 305 is successfully authenticated using the MDM certificate, at 358 the first portal 310 sends an agent configuration to the client 305, such as to configure the client 305 to connect to another entity (e.g., provisioning gateway 315) to obtain a persistent token. At 360, the client 305 selects the second gateway. For example, a user of the client 305 selects to connect to the second portal 325 and to access resource 330 behind a second gateway, which is a gateway that resides behind the first gateway 320 and provides an additional layer of security for resource 330. At 362, the client 305 initiates a second gateway connection. In response to receiving the request to initiate the second gateway connection, at 364, the provisioning gateway 315 challenges client 305 for a certificate (e.g., an MDM certificate or a persistent token certificate). As noted above, client 305 only has an MDM certificate and does not need to use a cached MDM certificate because the MDM application can access the MDM certificate without requiring an additional user intervention (e.g., without requiring the granting of an additional contemporaneous permission). At 366, the client 305 provides the MDM certificate to the provisioning gateway 315 and the provisioning gateway 315 authenticates the client 305 based on the MDM certificate. In response to determining that the client 305 is successfully authenticated using the MDM certificate, at 368, the second portal is provisioned for client 305. In some embodiments, the provisioning of the second portal 325 for client 305 includes installing a token resource on client 305. For example, the provision token is installed on client 305. For example, in response to determining that the client 305 is successfully authenticated using the MDM certificate, the provisioning gateway 315 provisions a persistent token for the client 305 to access the second portal 325. At 370, the client 305 selects the best available gateway. For example, the client 305 determines the gateway (e.g., the first gateway) via which the second portal 325 and/or second gateway is to be accessed for client 305 to access resources 330. At 372, the client 305 initiates a gateway connection with first gateway 320. In response to receiving the request to initiate the gateway connection, at 374, the first gateway 320 challenges client 305 for the persistent token certificate. For example, the first gateway 320 sends to client 305 a request for the persistent token certificate to authenticate client 305 with the first gateway 320. In some embodiments, first gateway 320 will prompt client 305 for the persistent token. However, the MDM certificate will not match this challenge (e.g., the MDM certificate will not be responsive to the request from first gateway 320 for the persistent token). Accordingly, client 305 will perform a search through the system keychain and find the persistent token. Client 305 can then prompt the user for access to this persistent token. Because the application or task running on client 305 does not have wildcard access to use the persistent token as needed, at 376, the client 305 prompts the user to provide authorization to access the persistent token. In response to the user providing the express authorization to access the persistent token, the client 305 uses the persistent token certificate for the persistent token to authenticate with the first gateway 320. For example, at 378, client 305 sends the persistent token certificate to first gateway 320 in connection with the authentication of client 305. In response to the client 305 being authenticated based on the persistent token certificate, the persistent token certificate is cached, such as in the client device keychain. At 380, the client 305 accesses resources 330 via first gateway 320. The client 305 can continue to access the resources 330 during the session. At 382, the session for which client 305 accesses resources 330 times out. The session can timeout after a predefined period of time (e.g., a time from the initiation of the session). Alternatively, the session may be ended by client 305 (e.g., in response to a user selecting to end the session) or by an administrator of second portal 325. Once the session for accessing the resources 330 ends or times out, client 305 is required to authenticate with the second portal 325/second gateway (e.g., the enterprise network behind the security service gateway) using the persistent token certificate. However, in subsequent authentications, the client 305 can use the cached persistent token certificate that was stored in the client device keychain after the initial successful authentication using the persistent token certificate.

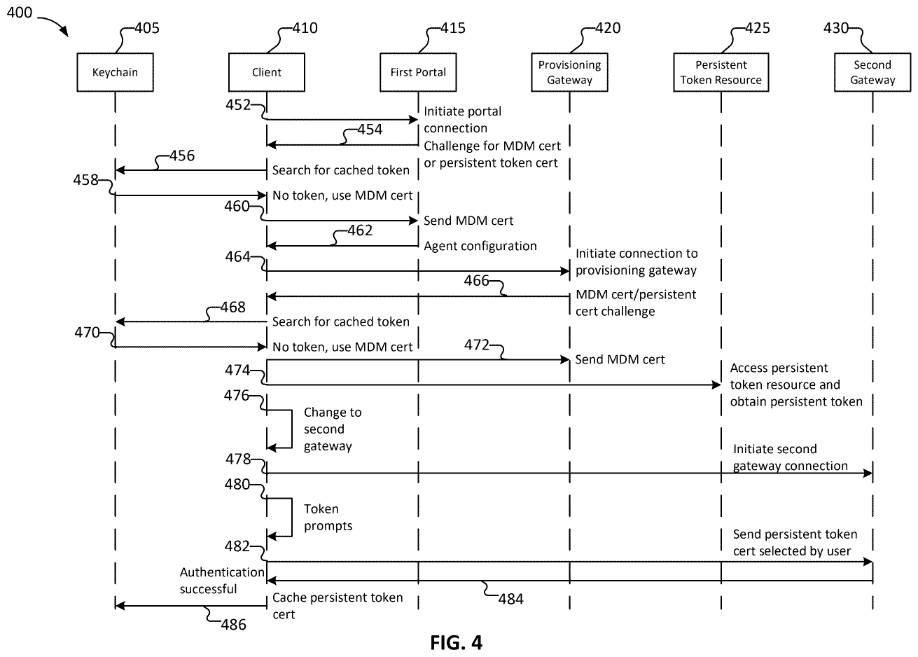

FIG. 4 is a sequence diagram for using a persistent token certificate that is not cached locally at a client device when authenticating to access resources behind a second gateway according to various embodiments. In the example shown, system 400 comprises client 410 (e.g., a client device), a keychain 405 (e.g., the keychain comprised in the client device), a first portal 415, a provisioning gateway 420, a persistent token resource 425, and/or a second gateway 430.

At 452, client 410 initiates a portal connection with the first portal 415. In response to receiving the request to initiate the portal connection, at 454, the first portal 415 challenges client 410 for an MDM certificate or a persistent token certificate. In some embodiments, first portal 415 challenges client 410 for the MDM certificate and the persistent token certificate for the purpose of being able to authenticate client 410 using a single certificate in subsequent connections. For example, when client 410 has a cached token to the second gateway 430, instead of having to revert back to using the MDM certificate for the portal authentication and then the token for the second gateway 430, client 410 can directly use the cached token (e.g., the cached persistent token certificate) to authenticate to both. In some embodiments, the permissions of the MDM certificate is a subset of the permissions of the persistent token. At 456, client 410 searches for a locally stored cached token (or corresponding cached certificate). For example, client 410 performs a lookup in keychain 405. At 458, client 410 determines that keychain 405 does not store the cached persistent token certificate and client 410 accordingly determines to use the MDM certificate in connection with authenticating with first portal 415. At 460, client 410 provides the MDM certificate to first portal 415 and first portal 415 authenticates client 410 based on the MDM certificate. In response to determining that client 410 is successfully authenticated using the MDM certificate, at 462 the first portal 415 sends an agent configuration to client 410, such as to configure client 410 to connect to another entity (e.g., provisioning gateway 420) to obtain a persistent token. At 464, client 410 initiates a connection to the provisioning gateway. In response to receiving the request to initiate the provisioning gateway connection, at 466, the provisioning gateway 420 challenges client 410 for a certificate (e.g., an MDM certificate or a persistent token certificate). In response to receiving the challenge for a certificate, at 468, client 410 searches for a locally stored persistent token (e.g., a cached persistent token or corresponding persistent token certificate). For example, client 410 can search keychain 405. At 470, client 410 determines that the persistent token is not stored locally at client 410 (e.g., cached at keychain 405), and the client uses the MDM certificate. At 472, client 410 provides the MDM certificate to the provisioning gateway 420 and the provisioning gateway 315 authenticates client 305 based on the MDM certificate. In response to determining that client 410 is successfully authenticated using the MDM certificate, at 474, client 410 is provided access to a persistent token resource 425. For example, in response to client 410 being authenticated with provisioning gateway 420, client 410 can obtain a persistent token (e.g., the provisioning gateway 420 or other persistent token resource 425 can push the persistent token to client 410). At 476, client 410 changes to access the second gateway 430, such as in connection with accessing the resources behind second gateway using the newly obtained persistent token. At 478, client 410 initiates the second gateway connection. For example, client 410 sends a request to connect to/access the second gateway 430. The second gateway 430 may challenge client 410 for the persistent token (e.g., the corresponding persistent token certificate). Because the application or task running on client 410 does not have wildcard access to use the persistent token as needed, at 480, client 410 prompts the user to provide authorization to access the persistent token. In response to the user providing the express authorization to access the persistent token, client 410 uses the persistent token certificate for the persistent token to authenticate with the second gateway 430. For example, at 482, client 410 sends the persistent token certificate to second gateway 430 in connection with the authentication of client 410. In response to client 410 being authenticated based on the persistent token certificate, at 484, second gateway 430 provides client 410 with an indication that authentication using the persistent token was successful. In response to determining that the authentication with second gateway 430 is successful, at 486, the client 410 can cache the persistent token certificate, such as in keychain 405. According to various embodiments, the client 410 uses the cached persistent token certificate to authenticate with second gateway 430 during subsequent authentications. As such, in such subsequent authentications with the second gateway 430, client 410 does not need to prompt (e.g., as in 480) the user to provide authorization for the application to use the persistent token to authenticate with the second gateway 430. In some embodiments, keychain 405 also stores context for which the persistent token certificate is cached, such as the applications authorized to use persistent token certificate or tasks for which they can be used.

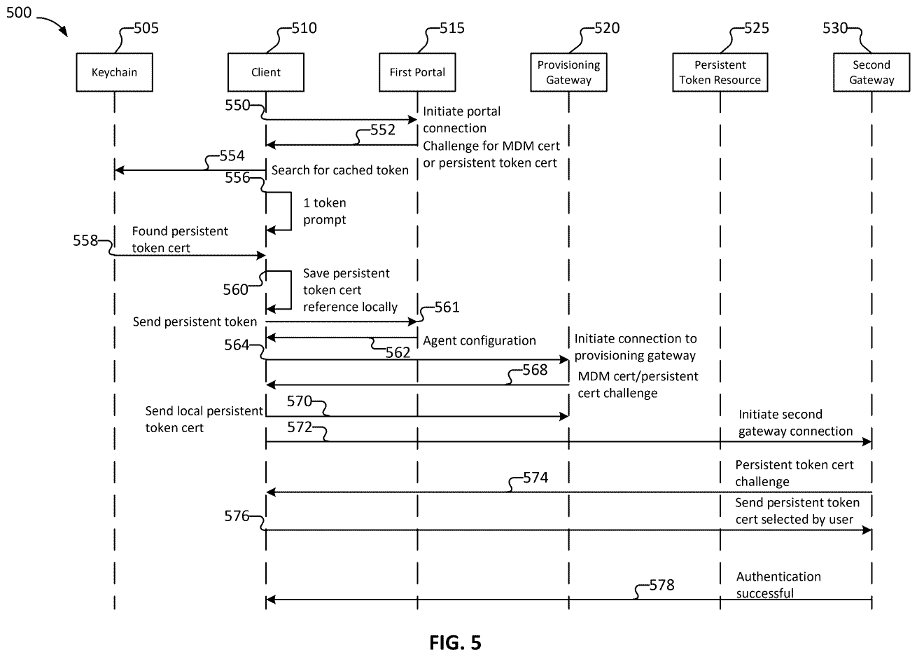

FIG. 5 is a sequence diagram for using a cached persistent token certificate when authenticating to access resources behind a second gateway according to various embodiments. In the example shown, system 500 comprises client 510 (e.g., a client device), a keychain 505 (e.g., the keychain comprised in the client device), a first portal 515, a provisioning gateway 520, a persistent token resource 525, and/or a second gateway 530.

At 550, client 510 initiates a portal connection with the first portal 515. In response to receiving the request to initiate the portal connection, at 552, the first portal 515 challenges client 410 for an MDM certificate or a persistent token certificate. At 554, client 510 searches for a locally stored cached token (or corresponding cached certificate). For example, client 510 performs a lookup in keychain 505 for a cached certificate (e.g., a cached persistent token certificate). At 556, the client 510 performs a token prompt. In some embodiments, client devices (e.g., client 510) can have N number of tokens installed for various reasons, meaning that user of the client devices will be prompted N number of times for access permission. Without a caching mechanism, the user has to grant permission for each one of those tokens that match the authentication challenge every time the client device is to establish a VPN connection. However, with the caching mechanism according to various embodiments, they will only have to experience this authentication prompt on the first authentication. Afterwards, the client device knows which token to refer to based on the cache. Accordingly, using the caching mechanism according to various embodiments will result in a single prompt. At 558, client 510 determines that keychain 505 comprises the persistent token certificate. At 560, client 510 obtains information pertaining to the persistent token certificate from the keychain 505 and saves the persistent token certificate reference locally for use by client 510 (e.g., by an application). At 561, client 510 sends the persistent token (e.g., the persistent token certificate) to first portal 515, such as to complete authentication. At 562, the first portal 515 sends an agent configuration to client 510, such as to configure client 510 to connect to another entity (e.g., provisioning gateway 520) to authenticate with the other entity or to obtain a persistent token. At 564, client 510 initiates a connection to the provisioning gateway. In response to receiving the request to initiate the provisioning gateway connection, at 568, the provisioning gateway 520 challenges client 510 for a certificate (e.g., an MDM certificate or a persistent token certificate). In response to receiving the certificate challenge, client 510 authenticates with provisioning gateway 520 using the persistent token certificate (e.g., a cached persistent token certificate). For example, client 510 provides the persistent certificate token to provisioning gateway 520. In response to successfully authenticating with provisioning gateway 520, client 510 initiates a second gateway connection. In response to receiving the request to initiate the second gateway connection, at 574, the second gateway 530 challenges client 510 for a certificate (e.g., a persistent token certificate). In response to receiving the certificate challenge, client 510 authenticates with second gateway 530 using the persistent token certificate (e.g., a cached persistent token certificate). For example, client 510 provides the persistent certificate token to second gateway 530. In response to receiving the persistent certificate token, second gateway 530 authenticates client 510 based on the received persistent token certificate. In response to determining that client 510 is successfully authenticated based on the persistent token certificate, at 578, second gateway 430 provides to client 510 an indication that the authentication is successful. Client 510 may then access resources residing behind second gateway 530 after the successful authentication with the second gateway 530.

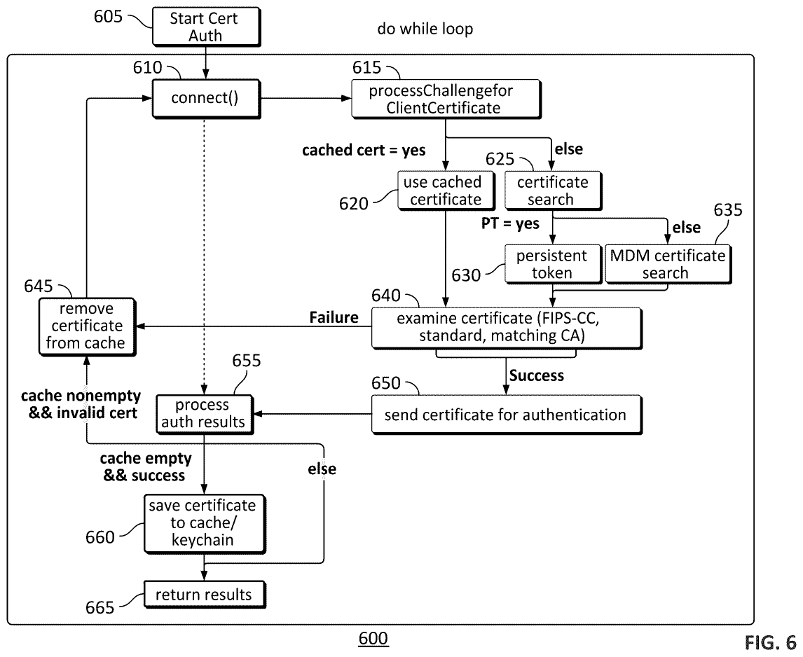

FIG. 6 is a sequence diagram for using a persistent token certificate for a persistent token in connection with authenticating a client when accessing resources behind a second gateway according to various embodiments. In some embodiments, process 600 is implemented by a client device.

At 605, the system obtains an indication to start a certificate authentication. For example, the system may invoke process 600 in response to determining that the system is to be authenticated with a particular authentication entity, such as in response to determining that the system is to initiate a connection to a network entity. At 610, the system initiates a connection to a network entity. In response to initiating the connection, the system receives a certificate challenge from an authentication entity (e.g., a gateway, a portal, etc.). At 615, the system invokes a process for identifying and obtaining an appropriate certificate in response to a certificate challenge. For example, at 615, the system determines whether the system stores a cached certificate (e.g., a cached persistent token certificate). The system can query the client device keychain for a cached persistent token certificate (e.g., a certificate associated with the authentication entity). If the system determines that the client device (e.g., the keychain) stores the cached persistent certificate, at 620, the system determines to use the cached persistent token certificate. The system can then proceed to 640. Conversely, if the system determines that the client device does not store the cached persistent token certificate, at 625, the system performs a search for a locally stored certificate (e.g., a persistent token certificate for a persistent token or an MDM certificate for an MDM token). For example, at 625, the system determines whether the client device locally stores a persistent token certificate. In response to determining that the client device locally stores a persistent token certificate, process 600 proceeds to 630 at which the system obtains the persistent token certificate for the persistent token. Conversely, in response to determining that the client device does not locally store a persistent token, process 600 proceeds to 635 at which the system performs an MDM certificate search and obtains the MDM certificate for the MDM token. At 640, the system examines the certificate obtained at 620, 630, or 635. For example, the system examines the cached persistent token certificate if the client device has a cached persistent token certificate, the persistent token certificate for a locally stored persistent token, or the MDM certificate for a locally stored MDM token. The system can examine the certificate in connection with determining whether the certificate is valid, such as based on whether the certificate has expired, matches the certificate authority associated with the system for which the client device is attempting authentication, and/or is compliant with FIPS. If the system determines that the obtained certificate is valid, process 600 proceeds to 650 at which the system provides (e.g., sends) the certificate for authentication. For example, the system sends the obtained certificate to the authentication entity that issued the certificate challenge. At 655, the system obtains the authentication results (e.g., from the authentication entity to which the system had sent the certificate) and processes the authentication results. If the system determines that the authentication was successful and the cache was empty (e.g., that the local cache, or keychain, did not store a cached persistent token certificate), then process 600 proceeds to 660 at which the system saves the certificate to the local cache (e.g., the client device keychain), which can then be used for subsequent authentications. Thereafter, process 600 proceeds to 665. If the system determines that the authentication was successful and the certificate used for authentication was obtained from local cache (e.g., that the client device keychain was non-empty and stored the cached persistent token certificate), then process 600 proceeds to 665 at which the system returns the results. For example, upon successful authentication of the system, the system may access resources behind the authentication entity that performed authentication. The system can invoke an application, process, or service for the accessing of such resources. If the system determines, based on the authentication results, that authentication was unsuccessful, the system determines the certificate to be invalid. If the system did not use a cached certificate for the unsuccessful authentication, then in various embodiments process 600 may end, process 600 may return to 610, and/or another process for obtaining a provisioned certificate may be invoked. In some embodiments, if authentication is unsuccessful without using a cached certificate, process 600 proceeds to 665, which can then be handled by the application on the client device to display to the user that the certificate is invalid and authentication has failed. If the system determines that authentication was unsuccessful based on the authentication results, and that the system had used a cached certificate (e.g., that the client device cache or keychain was non-empty and a cached persistent token certificate was used for authentication), then process 600 proceeds to 645 at which the system removes the cached certificate from the cache. For example, in the event that the system used a cached persistent token certificate for authentication and the authentication was unsuccessful, the system determines that the cached persistent token certificate is invalid and removes such certificate from the local cache (e.g., the client device keychain), for example, to ensure that the system does not attempt to use that certificate in subsequent authentications (e.g., an instead obtains a newly provisioned persistent token certificate).

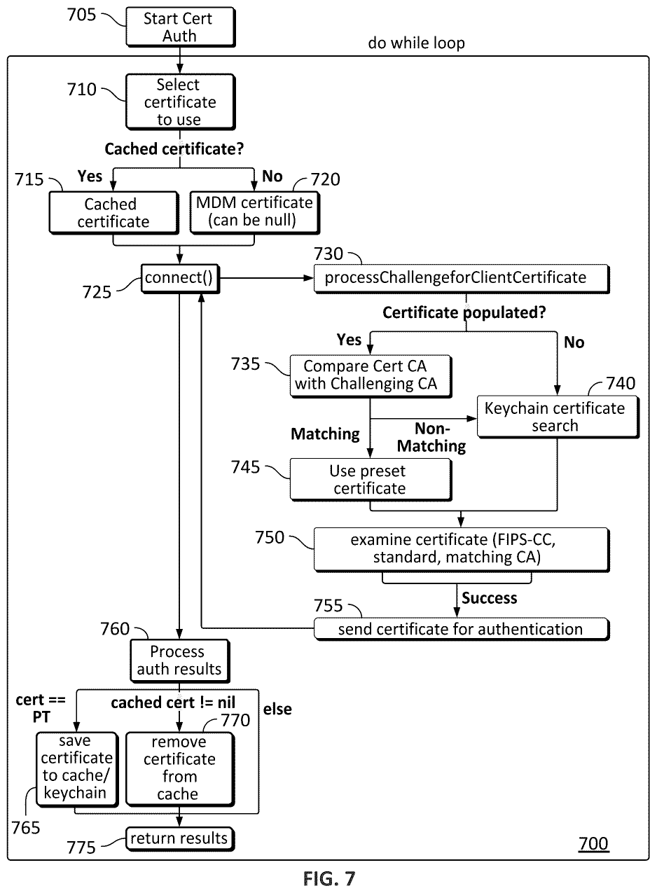

FIG. 7 is a sequence diagram for using a persistent token certificate for a persistent token in connection with authenticating a client when accessing resources behind a second gateway according to various embodiments. In some embodiments, process 700 is implemented by a client device.

At 705, the system obtains an indication to start a certificate authentication. For example, the system may invoke process 700 in response to determining that the system is to be authenticated with a particular authentication entity, such as in response to determining that the system is to initiate a connection to a network entity. At 710, the system selects a certificate to use for authentication. In some embodiments, the certificate selection in this case only checks to determine if there is a cached certificate and if not, then use the MDM certificate. In some embodiments, the system prompts the user only when the system does do a keychain search and finds a plurality of certificates matching the authentication challenge. For example, the system can prompt the user to select the certificate from among the plurality of certificates matching the authentication challenge (e.g., display a user interface from which the user selects the appropriate certificate). As another example, the system can automatically determine the certificate to use for authentication based on the context, such as based on whether the system has a persistent token for the authentication entity (e.g., for the desired authentication), etc. For example, at 710, the system determines whether the system stores a cached certificate (e.g., a cached persistent token certificate). The system can query the client device keychain for a cached persistent token certificate (e.g., a certificate associated with the authentication entity). If the system determines that the client device (e.g., the keychain) stores the cached persistent certificate, at 710, the system determines to use the cached persistent token certificate and process 700 proceeds to 715 at which the system obtains the cached certificate (e.g., the cached persistent token certificate or information pertaining to such certificate). The system can then proceed to 725. Conversely, if the system determines that the client device does not store the cached certificate (e.g., a cached persistent token certificate), then process 700 proceeds to 720 at which the system uses the MDM certificate (e.g., the system obtains the MDM certificate). Thereafter, process 700 proceeds to 725. At 725, the system initiates a connection to a network entity. In response to initiating the connection, the system receives a certificate challenge from an authentication entity (e.g., a gateway, a portal, etc.). At 730, the system invokes a process for identifying and obtaining an appropriate certificate in response to a certificate challenge. For example, the system determines whether the certificate is populated. In some implementations, the certificate can be null because there is a possibility that an enterprise network (e.g., the customer of the security service) is not using an MDM certificate but only persistent tokens. Accordingly, if the certificate is populated (has been found in the previous step), process 700 proceeds to 735. Otherwise, the system will do a keychain search for non-cached persistent token. If the system determines that the certificate is not populated, process 700 proceeds to 740 at which the system performs a keychain certificate search for the appropriate certificate. Conversely, if the system determines that the certificate is populated, then process 700 proceeds to 735 at which the system evaluates the certificate authority for the certificate being used to determine whether such certificate authority matches the certificate authority that is issuing the certificate challenge. If the system determines that the certificate authority for the certificate being used does not match the certificate authority that is issuing the certificate challenge, then process 700 proceeds to 740 at which the system performs a keychain certificate search for the appropriate certificate. If the system determines that the certificate authority for the certificate being used matches the certificate authority that is issuing the certificate challenge, process 700 proceeds to 745 at which the system uses the preset certificate. At 750, the system examines the certificate obtained at 740 or the populated certificate, such as the certificate selected at 710. For example, the system examines the cached persistent token certificate if the client device has a cached persistent token certificate, the persistent token certificate for a locally stored persistent token, or the MDM certificate for a locally stored MDM token. The system can examine the certificate in connection with determining whether the certificate is valid, such as based on whether the certificate has expired, matches the certificate authority associated with the system for which the client device is attempting authentication, and/or is compliant with FIPS. If the system determines that the obtained certificate is valid, process 700 proceeds to 725 at which the system provides (e.g., sends) the certificate for authentication in connection with the connection attempt. For example, the system sends the obtained certificate to the authentication entity that issued the certificate challenge. At 760, the system obtains the authentication results (e.g., from the authentication entity to which the system had sent the certificate) and processes the authentication results. In some embodiments, if the system determines that the authentication was successful and the cache was empty (e.g., that the local cache, or keychain, did not store a cached persistent token certificate), then process 700 proceeds to 765 at which the system saves the certificate to the local cache (e.g., the client device keychain), which can then be used for subsequent authentications. In some embodiments, if the system determines that the authentication was successful and the cache was empty, and that the certificate type is of a persistent token, then process 700 proceeds to 765 at which the system saves the certificate to the local cache. Thereafter, process 700 proceeds to 775. In some embodiments, if the system determines that the authentication was successful and the certificate type is not of a persistent token (e.g., an MDM certificate type was used for authentication) but the certificate cache is nonempty, the certificate is removed from the cache. For example, this outcome would mean that the cached certificate was not able to be used for various reasons. In some embodiments, if the system determines that the authentication was not successful and the certificate used for authentication was obtained from local cache (e.g., that the client device keychain was non-empty and stored the cached persistent token certificate), then process 700 proceeds to 770 at which the system removes the certificate from the cache. Process 700 can then proceed to 775 or the system can reattempt to initiate a connection and authenticate with a particular network entity using a different certificate, such as a newly obtained certificate for a token obtained from a provisioning gateway. In some embodiments, if the system determines that the authentication was successful and that the system used a cached certificate (e.g., the cached persistent token certificate) for authentication, then process 700 proceeds to 775. Otherwise, if the system determines that the authentication was not successful and the certificate used for authentication was not obtained from a local cache, process 700 can then proceed to 775 or the system can reattempt to initiate a connection and authenticate with a particular network entity using a different certificate, such as a newly obtained certificate for a token obtained from a provisioning gateway. In some embodiments, rather than performing 775, process 700 ends upon determination that authentication fails. The client device (e.g., the user) can manually request/invoke process 700 again in connection with a new connection/authentication.

In some embodiments, evaluating whether the certificate is FIPS-CC compliant include enforcing strict X.509v3 verification checks on the certificate. The verifications checks are based on NIAP's FIA_X509_EXT.1 and FIA_X509_EXT.2 certificate validation and authentication requirements. Conversely, in standard examination, the system evaluates a certificate's validity to establish trust for a particular use—for example, in creating a digital signature or to establish a Secure Sockets Layer connection, along with CRL, OCSP and EKU checks.

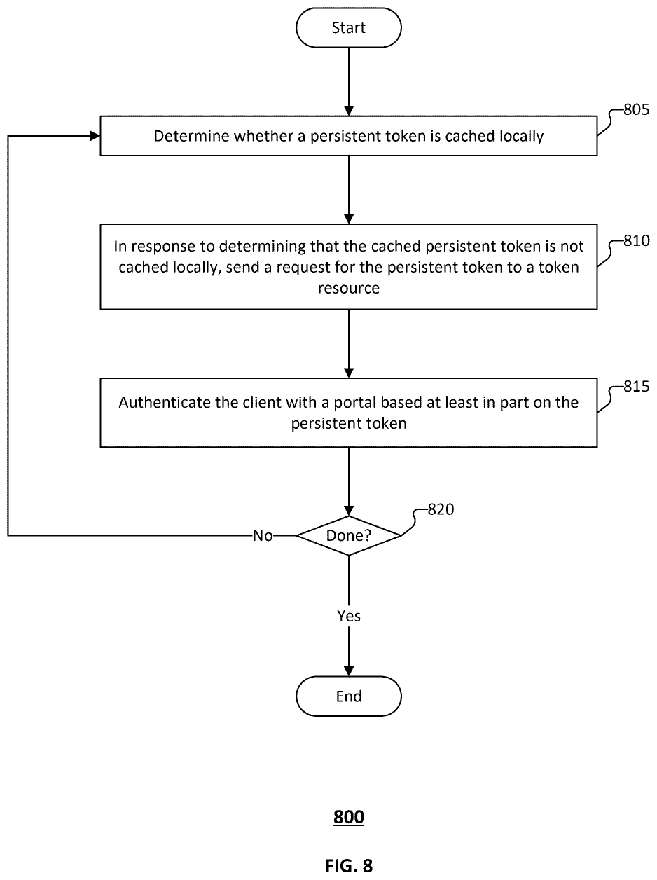

FIG. 8 is a flow diagram of a method for using a persistent token for authenticating a client with a portal according to various embodiments. In some embodiments, process 800 is implemented at least in part by system 100 of FIG. 1, system 300 of FIGS. 3A and 3B, system 400 of FIG. 4, and/or system 500 of FIG. 5. In some embodiments, process 800 is implemented by a client device, such as a mobile device that also runs (or has installed) an MDM application.

At 805, the system determines whether a persistent token is cached locally. In some embodiments, at 810, in response to determining that the cached persistent token is not cached locally, the system sends a request for the persistent token to a token resource. If a persistent token is not cached in the keychain, the system (e.g., the client device) will fallback to using the MDM certificate. In the case that the MDM certificate does not match the challenging CA or if there is no MDM certificate at all, the system (e.g., the client device) would then do a keychain search for persistent tokens. At 815, the system authenticates the client with a portal based at least in part on the persistent token. At 820, a determination is made as to whether process 800 is complete. In some embodiments, process 800 is determined to be complete in response to a determination that no further persistent tokens are to be obtained, no further authentications of the client are to be performed, no input has been received by the user to re-initiate a connection/authentication an administrator indicates that process 800 is to be paused or stopped, etc. In response to a determination that process 800 is complete, process 800 ends. In response to a determination that process 800 is not complete, process 800 returns to 805. In some embodiments, rather than performing 820, process 800 ends upon determination that authentication fails. The client device (e.g., the user) can manually request/invoke process 800 again in connection with a new connection/authentication.

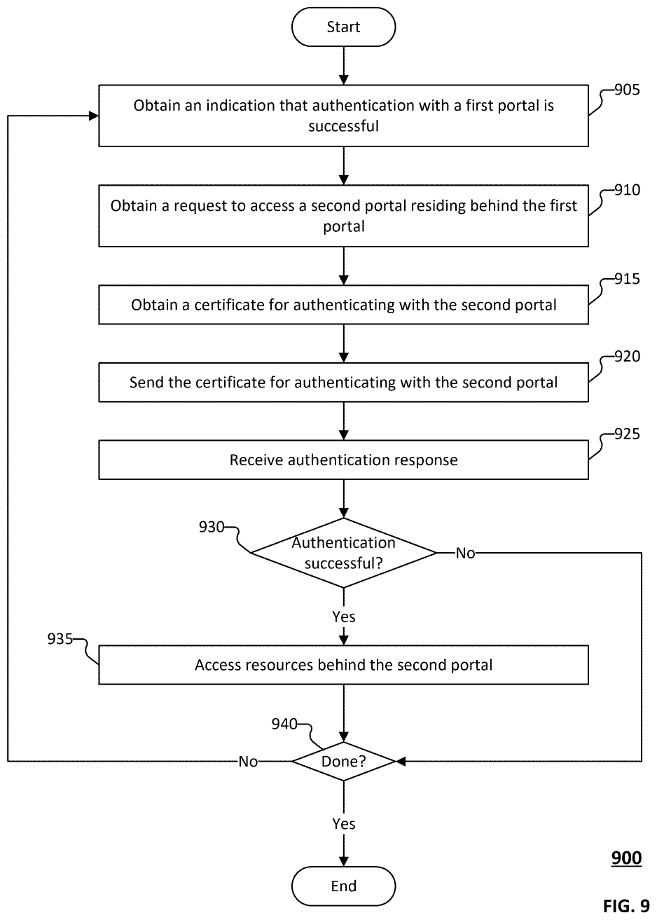

FIG. 9 is a flow diagram of a method for using a persistent token for authenticating a client with a second portal in connection with accessing resources behind a second portal that is behind a first portal according to various embodiments. In some embodiments, process 900 is implemented at least in part by system 100 of FIG. 1, system 300 of FIGS. 3A and 3B, system 400 of FIG. 4, and/or system 500 of FIG. 5. In some embodiments, process 900 is implemented by a client device, such as a mobile device that also runs (or has installed) an MDM application.

According to various embodiments, after authenticating to the first portal with the MDM certificate, the system (e.g., the client/client device) then authenticates to the provisioning gateway. Upon connecting to this gateway, the system receives access to the persistent token resource. The system (e.g., the client/client device) then changes gateway to the second gateway, which prompts the client for a persistent token. The client then uses the obtained persistent token to authenticate and access internal resources.

At 905, the system obtains an indication that authentication with a first portal is successful. The first portal can authenticate a client/client device based at least in part on an MDM certificate or MDM token. At 910, the system obtains a request to access a second portal residing behind the first portal. In some embodiments, the second portal does not reside behind the first portal. Instead, the system changes gateways to connect to the second gateway upon receiving the persistent token. At 915, the system obtains a certificate for authenticating with the second portal. At 920, the system sends the certificate for authenticating with the second portal. At 925, the system receives an authentication response. At 930, the system determines whether the authentication is successful. In some embodiments, in response to determining that the authentication is not successful, process 900 may proceed to 940. Process 900 may iterate over 905-930 until the authentication is successful or until a user provides an indication to stop further attempts to authenticate with the second portal, etc. In some embodiments, rather than determining whether process 900 is complete and potentially re-iterating over 905, process 900 ends upon determination that authentication fails. The client device (e.g., the user) can manually request/invoke process 900 again in connection with a new connection/authentication. Conversely, in response to determining that the authentication is successful, process 900 proceeds to 935. At 935, the system accesses resources behind the second portal. The system may continue to access the resources behind the second portal until the session has timed-out or earlier terminated by a user of the client device or system administrator. If the session times out or the user wants to initiate a new session, the system can iterate over 905-935 and re-authenticate the client device based on the certificate for authenticating with the second portal (e.g., the persistent token certificate). At 940, a determination is made as to whether process 900 is complete. In some embodiments, process 900 is determined to be complete in response to a determination that no further authentications of the client are to be performed, no further resources behind the second portal are to be accessed, an administrator indicates that process 900 is to be paused or stopped, etc. In response to a determination that process 900 is complete, process 900 ends. In response to a determination that process 900 is not complete, process 900 returns to 905. In some embodiments, rather than determining whether process 900 is complete and potentially re-iterating over 905, process 900 ends upon determination that authentication fails. The client device (e.g., the user) can manually request/invoke process 900 again in connection with a new connection/authentication.

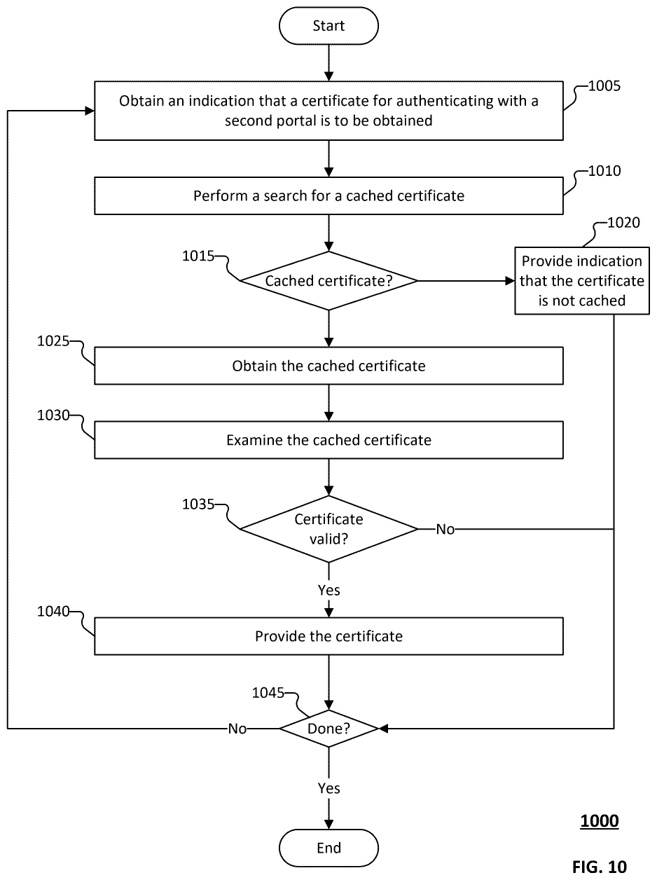

FIG. 10 is a flow diagram of a method for using a persistent token for authenticating a client to access resources behind a plurality of gateways according to various embodiments. In some embodiments, process 1000 is implemented at least in part by system 100 of FIG. 1, system 300 of FIGS. 3A and 3B, system 400 of FIG. 4, and/or system 500 of FIG. 5. In some embodiments, process 1000 is implemented by a client device, such as a mobile device that also runs (or has installed) an MDM application.

At 1005, the system obtains an indication that a certificate for authenticating with a second portal is to be obtained.

At 1010, the system performs a search for a cached certificate. For example, in response to determining that a persistent token certificate is to be used to authenticate the client device, the system can first determine whether the persistent token certificate is cached locally, such as in the client device's keychain.

At 1015, the system determines whether the certificate is cached.

In some embodiments, in response to determining that the certificate is not cached, process 1000 proceeds to 1020 at which the system provides an indication that the certificate is not cached. The system may further invoke another process or service for obtaining a non-cached certificate for use in connection with the authentication attempt. Process 1000 can then proceed to 1045.

In some embodiments, in response to response to determining that the certificate is not cached, process 1000 proceeds to initiate a keychain search to determine/identify a token that can be used for authentication. For example, the system examines all certificates used for authentication regardless of whether the certificate is obtained from the cache or not.

Conversely, in response to determining that the certificate is cached, process 1000 proceeds to 1025 at which the system obtains the cached certificate. For example, the system obtains the cached certificate from the client device's keychain or other certificate caching mechanism.

According to various embodiments, after obtaining the cached certificate at 1025, the system performs a certificate authority check to determine whether the certificate CA matches the challenging CA. In response to determining that the certificate CA matches the challenging CA, process 1000 can then proceed to 1030. In response to determining that the certificate CA does not match the challenging CA, then the system proceeds to use the MDM certificate for authentication. If the MDM certificate does not exist or the CA for the MDM certificate does not match the challenging CA, then the system can perform another keychain search and evaluate the next found certificate. Conversely, if the MDM certificate CA matches the challenging CA, process 1000 can then proceed to 1030.

At 1030, the system examines the certificate. The system can examine the certificate in connection with determining whether the cached certificate is valid, such as based on whether the certificate has expired, matches the certificate authority associated with the system for which the client device is attempting authentication, and/or is compliant with FIPS.

At 1035, the system determines whether the certificate is valid. The system can determine whether the certificate is valid based at least in part on the results from examining the certificate. In response to determining that the certificate is not valid, process 1000 can proceed to 1045 and process 1000 can terminate or iterate once again in connection with obtaining the appropriate certificate. Conversely, in response to determining that the certificate is valid, process 1000 can proceed to 1040 at which the system provides the certificate. The system can provide the certificate to the system, process, or service that invoked process 1000. For example, the certificate can be provided to a service that is performing the process of authenticating the client device with the applicable portal or gateway (e.g., a second gateway, such as a gateway that resides behind a first gateway authenticated using an MDM certificate).

At 1045, a determination is made as to whether process 1000 is complete. In some embodiments, process 1000 is determined to be complete in response to a determination that no further authentications of the client are to be performed, no further resources behind the second portal are to be accessed, an administrator indicates that process 1000 is to be paused or stopped, etc. In response to a determination that process 1000 is complete, process 1000 ends. In response to a determination that process 1000 is not complete, process 1000 returns to 1005. In some embodiments, rather than performing 1045, process 1000 ends upon determination that authentication fails. The client device (e.g., the user) can manually request/invoke process 1000 again in connection with a new connection/authentication.

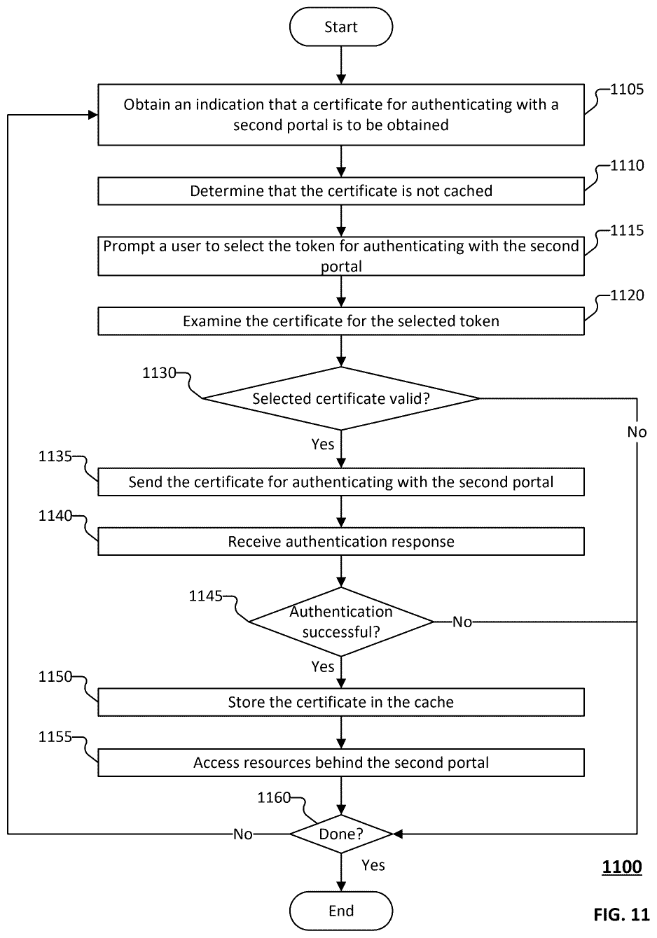

FIG. 11 is a flow diagram of a method for using a persistent token certificate that is not cached when authenticating a client to access resources behind a plurality of gateways according to various embodiments. In some embodiments, process 1100 is implemented at least in part by system 100 of FIG. 1, system 300 of FIGS. 3A and 3B, system 400 of FIG. 4, and/or system 500 of FIG. 5. In some embodiments, process 1100 is implemented by a client device, such as a mobile device that also runs (or has installed) an MDM application.

At 1105, the system obtains an indication that a certificate for authenticating with a second portal is to be obtained. For example, process 1100 is invoked when a system, service, or process is attempting to access resources behind the second portal or otherwise authenticate with the second portal. At 1110, the system determines that the certificate is not cached. For example, the system can perform a lookup against the client device's keychain or other caching mechanism to determine whether the appropriate certificate is cached. At 1115, the system prompts a user to select the token for authenticating with the second portal. For example, the system performs a search to determine the tokens and/or corresponding certificates that are stored locally on the device, which can be accessed to authenticate with the second portal. In some embodiments, the system searches the device for persistent tokens, such as a token stored in an application (e.g., an application that is different from an MDM application that manages an MDM token and/or corresponding MDM certificate). The system receives a user input corresponding to selection of a token to be used to authenticate with the second portal. At 1120, the system examines the certificate for the selected token. The system can examine the certificate in connection with determining whether the cached certificate is valid, such as based on whether the certificate has expired, matches the certificate authority associated with the system for which the client device is attempting authentication, and/or is compliant with FIPS. At 1130, the system determines whether the selected certificate is valid. The system can determine whether the cached certificate is valid based at least in part on the results from examining the certificate. In response to determining that the cached certificate is not valid, process 1100 can proceed to 1160 and process 1100 can terminate or iterate once again in connection with obtaining the appropriate certificate. Conversely, in response to determining that the cached certificate is valid, process 1100 can proceed to 1135 at which the system sends the certificate for authenticating with the second portal. For example, the system provides the certificate to the other system, service, or process performing the authentication with the second portal, which in turn can communicate the certificate to the second portal. At 1140, the system receives an authentication response. For example, the system receives a response indicating whether the authentication with the certificate was successful. At 1145, the system determines whether the authentication is successful. In response to determining that the authentication (e.g., with the second portal using the cached certificate) was not successful, process 1100 may proceed to 1160 and process 1100 may end or process 1100 may iterate again to authenticate the client device with a certificate (e.g., the system may use the MDM token or corresponding MDM certificate in the event that a persistent token is not available, and the system can obtain the appropriate persistent token from a provisioning authority/gateway after authentication using the MDM token or MDM certificate). In response to determining that the authentication (e.g., with the second portal using the cached certificate) is successful, process 1100 proceeds to 1150 at which the system stores the certificate in the cache. For example, the system stores the certificate in the client device's keychain or other caching mechanism. Accordingly, the system can obtain the certificate from the cache for subsequent authentications (e.g., without prompting the user to select, and authorize use of, the appropriate token). At 1155, the system accesses the resources behind the second portal. At 1160, a determination is made as to whether process 1100 is complete. In some embodiments, process 1100 is determined to be complete in response to a determination that no further authentications of the client are to be performed, no further resources behind the second portal are to be accessed, an administrator indicates that process 1100 is to be paused or stopped, etc. In response to a determination that process 1100 is complete, process 1100 ends. In response to a determination that process 1100 is not complete, process 1100 returns to 1105. In some embodiments, rather than performing 1160, process 1100 ends upon determination that authentication fails or succeeds. In the case of an authentication failure, the client device (e.g., the user) can manually request/invoke process 1100 again in connection with a new connection/authentication.

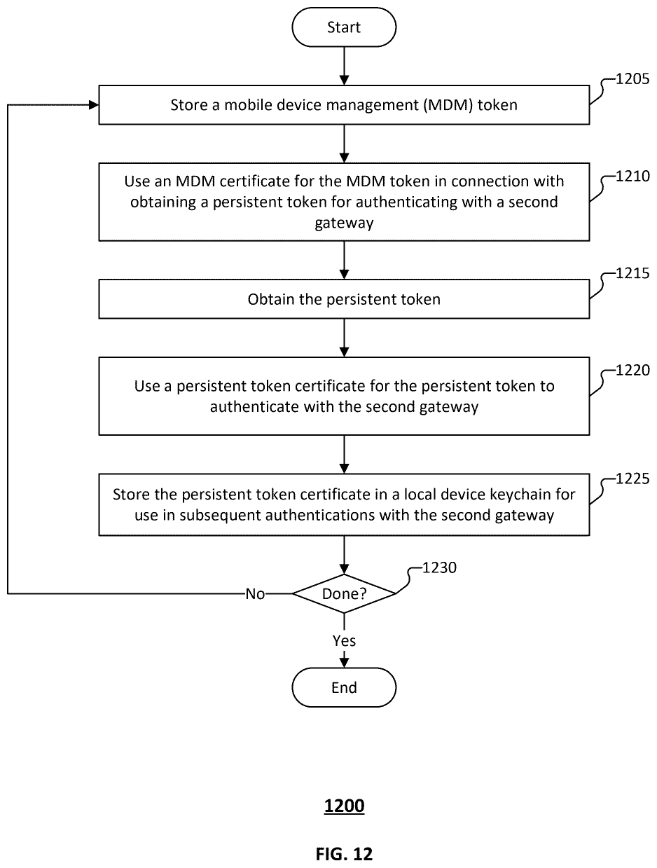

FIG. 12 is a flow diagram of a method for caching a persistent token certificate for subsequent authentications of a client when accessing resources behind a plurality of gateways according to various embodiments. In some embodiments, process 1200 is implemented at least in part by system 100 of FIG. 1, system 300 of FIGS. 3A and 3B, system 400 of FIG. 4, and/or system 500 of FIG. 5. In some embodiments, process 1200 is implemented by a client device, such as a mobile device that also runs (or has installed) an MDM application.

At 1205, the system stores a mobile device management (MDM) token. The system can store the MDM token in connection with the installation or configuration of an MDM application on a client device. At 1210, the system uses an MDM certificate for the MDM token in connection with obtaining a persistent token for authenticating with a second gateway. For example, the system uses the MDM certificate to authenticate the client device with a provisioning gateway or provisioning authority that provisions or otherwise provides the client device with a persistent token (e.g., a persistent token to be stored in another application on the client device. At 1215, the system obtains the persistent token. For example, a provisioning gateway can push the persistent token to an application running on the client device. At 1220, the system uses the persistent token certificate for the persistent token to authenticate with the second gateway. In some embodiments, the second gateway may reside behind a first gateway (e.g., which the client device can authenticate using an MDM certificate) and adds an additional layer of security for resources residing behind the second gateway. In some embodiments, in response to receiving the persistent token, the system (e.g., the client device) switches its connection from the first gateway to the second gateway. For example, the system initiates a connection with the second gateway and uses the newly received persistent token to authenticate with the second gateway. At 1225, the system stores the persistent token certificate in a local device keychain for use in subsequent authentications with the second gateway. At 1230, a determination is made as to whether process 1200 is complete. In some embodiments, process 1200 is determined to be complete in response to a determination that no further authentications of the client are to be performed, no further resources behind the second gateway are to be accessed, an administrator indicates that process 1200 is to be paused or stopped, etc. In response to a determination that process 1200 is complete, process 1200 ends. In response to a determination that process 1200 is not complete, process 1200 returns to 1205. In some embodiments, rather than performing 1225, process 1200 ends upon determination that authentication fails or succeeds. In the case of an authentication failure, the client device (e.g., the user) can manually request/invoke process 1200 again in connection with a new connection/authentication.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
determine whether a persistent token is cached locally on a client;
in response to determining that the cached persistent token is not cached locally on the client, send from the client a request for the persistent token to a token resource, and obtain a new persistent token; and
authenticate the client with a portal based at least in part on the persistent token;
wherein:
a cached persistent token is used for authentication in response to a determination that the cached persistent token is cached locally on the client; and
the new persistent token is used for authentication in response to a determination that the persistent token is not cached locally on the client; and
a memory coupled to the one or more processors and configured to provide the one or more processors with instructions.

2. The system of claim 1, wherein the client comprises a network security client running on a managed device.

3. The system of claim 2, wherein the network security client is a VPN client.

4. The system of claim 1, wherein authenticating the client with the portal based at least in part on the persistent token comprises:
authenticating the client with a first gateway based at least in part on a mobile device management (MDM) token; and
in response to the client being authenticated based at least in part on the mobile device; authenticating the client with a second gateway based at least in part on the persistent token.

5. The system of claim 4, wherein authenticating the client with the first gateway based at least in part on an MDM token comprises authenticating the client based at least in part on a cached MDM certificate for the MDM token.

6. The system of claim 4, wherein authenticating the client with the second gateway based at least in part on the persistent token comprises authenticating the client based on a persistent token certificate for the persistent token.

7. The system of claim 1, wherein authenticating the client with the portal based at least in part on the persistent token comprises obtaining a cached certificate for the persistent token from a keychain locally stored on the client, and using the cached certificate in connection with authenticating the client with the portal.

8. The system of claim 7, wherein the cached certificate for the persistent token is used in connection with authenticating the client with the portal in response to determining that the cached certificate is valid.

9. The system of claim 7, wherein the cached certificate for the persistent token is removed from the client in response to determining that the cached certificate is valid, and the client uses the persistent token to obtain a new certificate for the persistent token.

10. The system of claim 9, wherein the client uses the new certificate for the persistent token to authenticate the client, and in response to the client being authenticated, the new certificate is stored in a keychain locally stored on the client.

11. The system of claim 1, wherein the persistent token is valid for a predefined period of time.

12. The system of claim 1, wherein authenticating the client with the portal based at least in part on the persistent token comprises:
prompting a user to select whether to use a cached persistent token certificate or a mobile device management (MDM) token certificate.

13. The system of claim 1, wherein authenticating the client with the portal based at least in part on the persistent token comprises:
determining whether the client has a cached certificate for the persistent token; and
in response to determining that the client does not have a cached certificate for the persistent token, performing a certificate search for a certificate matching a certificate authority.

14. The system of claim 13, wherein in response to determining that a keychain locally stored on the client does not comprise a certificate matching a certificate authority when performing the certificate search, the client provides a prompt to a user that the client does not store a valid certificate.

15. The system of claim 1, wherein the client stores an indication of the persistent token used in connection with a particular authentication of the client.

16. The system of claim 1, wherein the client uses different persistent tokens and corresponding certificates for authentication with different gateways.

17. The system of claim 1, wherein in response to a determination that authentication of the client fails for a reason other than the persistent token, the client maintains the persistent token for future authentication attempts.

18. The system of claim 1, wherein obtain the new persistent token comprises receiving the new persistent token from a provisioning gateway.

19. A method, comprising:
determining whether a persistent token is cached locally on a client;
in response to determining that the cached persistent token is not cached locally on the client, sending from the client a request for the persistent token to a token resource, and obtaining a new persistent token; and
authenticating the client with a portal based at least in part on the persistent token;
wherein:
a cached persistent token is used for authentication in response to a determination that the cached persistent token is cached locally on the client; and
the new persistent token is used for authentication in response to a determination that the persistent token is not cached locally on the client.

20. A computer program product embodied in a non-transitory computer readable medium and comprising computer instructions for:
determining whether a persistent token is cached locally on a client;
in response to determining that the cached persistent token is not cached locally on the client, sending from the client a request for the persistent token to a token resource, and obtaining a new persistent token; and
authenticating the client with a portal based at least in part on the persistent token;
wherein:
a cached persistent token is used for authentication in response to a determination that the cached persistent token is cached locally on the client; and
the new persistent token is used for authentication in response to a determination that the persistent token is not cached locally on the client.
